(19) United States
(12) Patent Application Publication
(10) Pub. No.: US 2025/0271099 A1
(43) Pub. Date: Aug. 28, 2025

(54) POULTRY FEEDER AND WATERER WITH HANDLE AND SUPPORT PROVIDING AN ADJUSTABLE HEIGHT

(71) Applicant: Novelty Manufacturing Co., Lancaster, PA (US)

(72) Inventors: Joseph David DiMeo, Lititz, PA (US); Phillip Hall Hutchinson, Lititz, PA (US)

(21) Appl. No.: 19/061,989

(22) Filed: Feb. 24, 2025

Related U.S. Application Data
(60) Provisional application No. 63/556,865, filed on Feb. 22, 2024.

(51) Int. Cl. F16M 13/02; A01K 39/014; A01K 39/02

(52) U.S. Cl. CPC F16M 13/02; A01K 39/014; A01K 39/0213

(57) ABSTRACT

A support mounting mechanism for mounting an apparatus at an elevated height on a surface includes a support sleeve and an apparatus. The support sleeve has a substantially U-shaped profile and a length. The U-shape has a closed rear end and an open front end. The rear end of the U-shape is attachable to the surface. The apparatus has a handle with a length and a cross-sectional shape that seats in the U-shaped sleeve to hold the apparatus at the elevated height. The apparatus has an upper portion positioned above the handle that has a width that is larger than the width of the U-shaped profile such that the upper portion of the apparatus serves as a stop.

### CROSS-REFERENCE TO RELATED APPLICATION

This application claims priority to U.S. Provisional Application No. 63/556,865, filed on Feb. 22, 2024, the disclosure of which is incorporated herein by reference in its entirety.

### FIELD

The present invention relates to a support mechanism that provides an adjustable height for an attached apparatus. In particular, the present invention relates to a support mechanism for a poultry feeder and waterer to elevate the apparatus above the ground.

### BACKGROUND

Various types of poultry feeders and poultry waterers are known. It is preferred to have an elevated design that prevents feed waste. It is desirable that poultry feeders and waterers are designed to provide proper feed flow so that feeding ports remain clear and to reduce the risk of mold. Proper height elevation helps to minimize crowding, allowing multiple birds to feed simultaneously. Durability is also important.

It is desirable that feeders and waterers have adjustable heights. This has previously been provided by adjustable legs, like telescoping legs, which is advantageous because it permits for use of the same device by different bird sizes. For example, feed port heights of 9″, 13″, and 17″ are known, among other heights. Positioning the feeder and waterer off the ground also assists in deterring rodents. It is also desirable for feeders and waterers to be positioned in a stable manner so that they do not easily tip over.

### BRIEF DESCRIPTION OF THE DRAWINGS

FIG. 1 is a side perspective view of an example chicken waterer for use with a support mechanism that permits the chicken waterer to be elevated above the ground;

FIG. 2 is a rear view of the chicken waterer of FIG. 1 showing the handle of the chicken waterer;

FIG. 3 is a side view of the chicken waterer of FIG. 1 showing a side of the chicken waterer where a watering spout may be positioned;

FIG. 4 is a front view of the chicken waterer of FIG. 1 showing two sides of the chicken waterer where watering spouts may be positioned;

FIG. 5 side view of the chicken waterer of FIG. 1 showing a position for a watering spout and the handle;

FIG. 6 is a cross-sectional sectional view of the chicken waterer of FIG. 1 showing the cross-sectional shape of a handle taken above the apparatus and showing the inner bottom of the chicken waterer;

FIG. 7 is a top cross-sectional perspective view of the chicken waterer of FIG. 1 showing the shape of a handle;

FIG. 8 is a front view of a chicken feeder according to the invention showing two openings in the front of the chicken feeder;

FIG. 9 is a front view of one side of the chicken feeder openings shown in FIG. 8 for chicken feeding;

FIG. 10 is an enlarged front view of a chicken watering nipple for use with the chicken waterer of FIG. 1;

FIG. 11 is a perspective view of an example bracket or sleeve according to the invention;

FIG. 12 is a rear view of the bracket or sleeve shown in FIG. 11;

FIG. 13 is a side view of the bracket or sleeve shown in FIG. 11;

FIG. 14 is a top or bottom view of the bracket or sleeve shown in FIG. 11;

FIG. 15 is a rear perspective view of an example poultry waterer with the support bracket installed on the handle of the poultry waterer;

FIG. 16 is a rear view of the poultry waterer and support bracket shown in FIG. 15;

FIG. 17 is a side view of the poultry waterer and support bracket shown in FIG. 15; and

FIG. 18 is a bottom view of the poultry waterer and support bracket shown in FIG. 15.

### SUMMARY

A support mounting mechanism for mounting an apparatus at an elevated height on a surface includes a support sleeve and an apparatus. The support sleeve has a substantially U-shaped profile and the apparatus has a handle that seats in the U-shaped sleeve to hold the apparatus at the elevated height.

In another embodiment, a support mechanism for holding an apparatus at an elevated height above the ground includes a support bracket having a contour along its length that permits a handle having a similarly shaped contour to seat in the support bracket. The support bracket has a U-shaped profile with a closed rear end that is configured to attach to a separate supporting structure, an open front end, an open bottom end, and an open top end. The support bracket is shaped to accept a handle of an apparatus that slides downwardly into the support bracket. The apparatus is supported on the support bracket by a portion of the apparatus that is positioned above the handle of the apparatus. The support bracket is configured to suspend an apparatus above the ground solely by contact between the handle of the apparatus and the support bracket.

### DETAILED DESCRIPTION

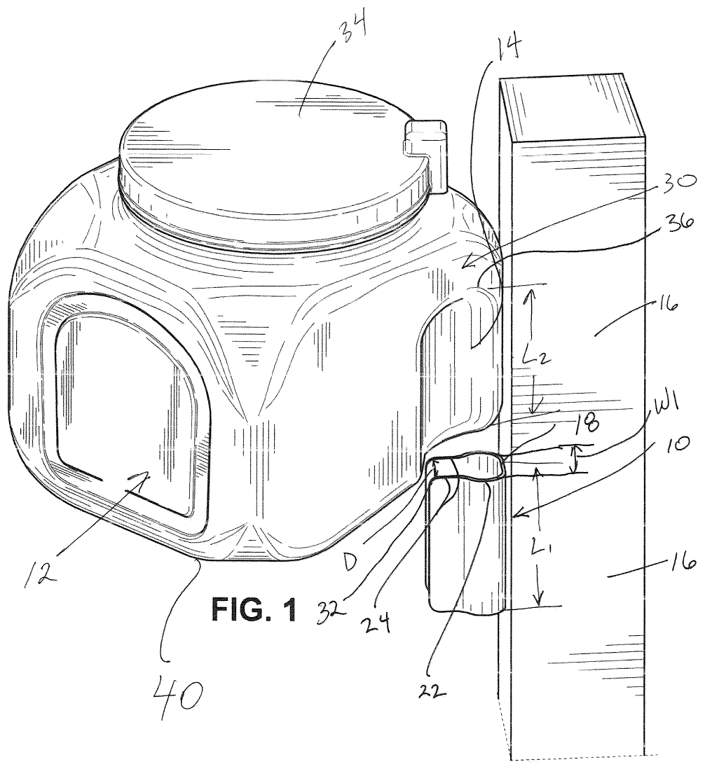

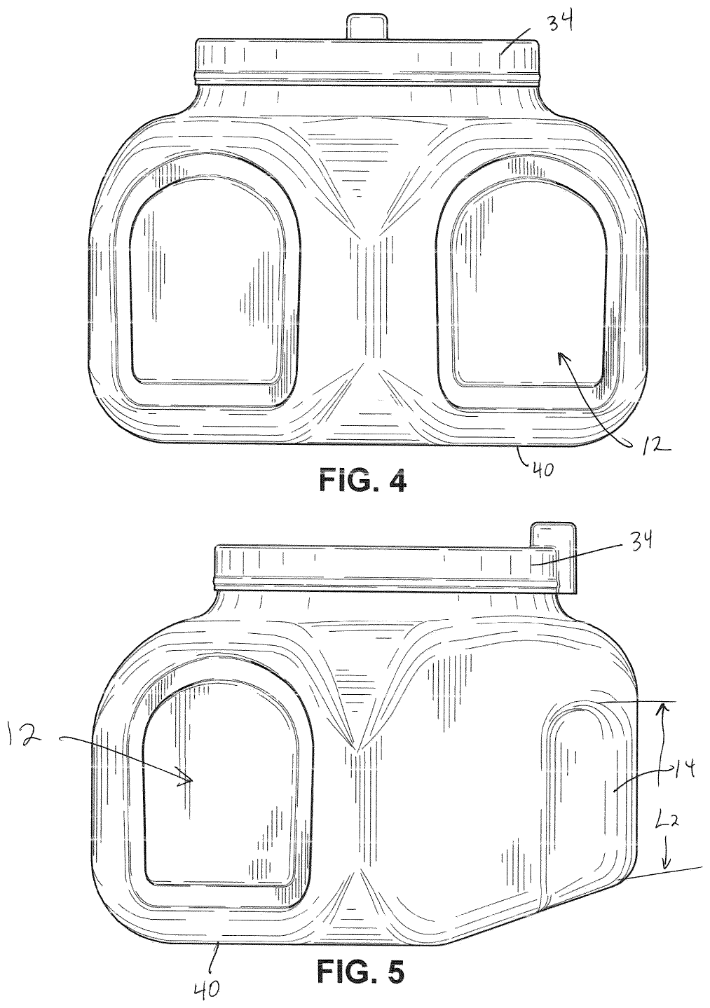

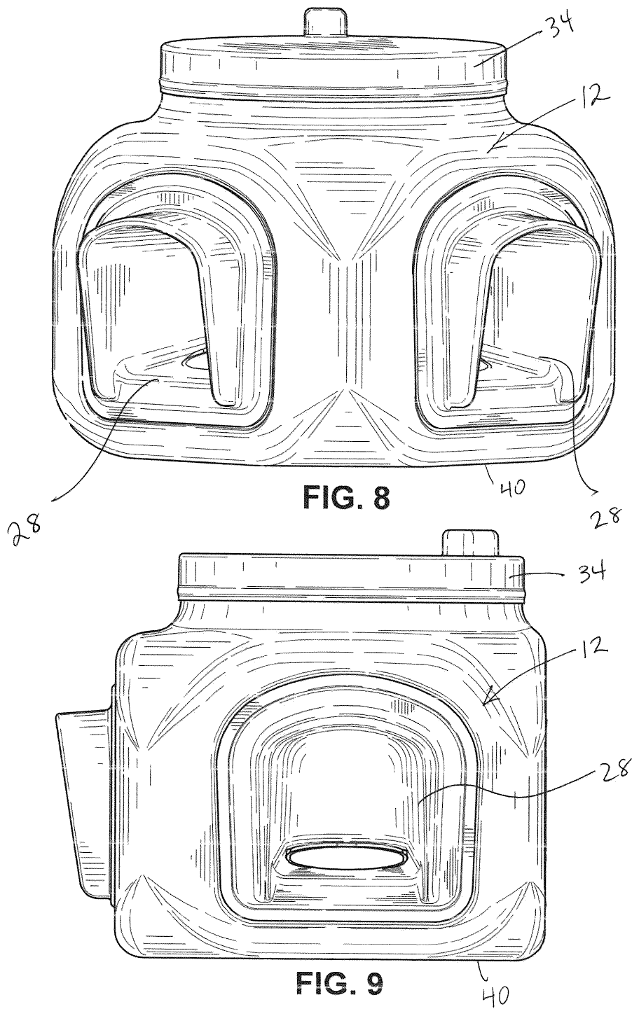

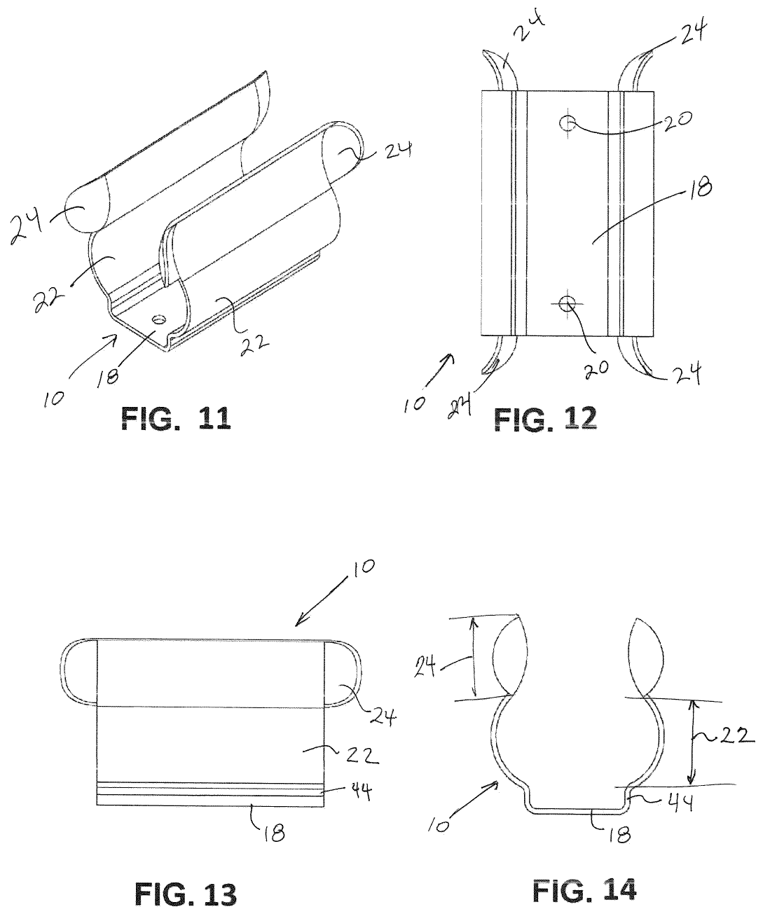

The present invention is directed toward a support mechanism 10 for an apparatus 12, such as a portable chicken waterer or chicken feeder. The figures show an example of both a chicken waterer and a chicken feeder. FIGS. 1-7, 10, and 15-18 depict a chicken waterer, FIGS. 8-9 depict a chicken feeder, and FIGS. 11-14 depict a support mechanism/bracket 10 for use with the apparatus 12. The present invention can be used with any type of feeder or waterer that has a handle 14 to permit the apparatus to be elevated above the ground. In addition, the present invention can be used to support any type of apparatus 12, as long as it has a handle 14 configured to seat in the support bracket described herein.

As discussed above, it is desirable to be able to adjust the height of a chicken feeder or waterer 12 based upon the size of the birds that utilize the chicken feeder or waterer. Elevating the apparatus 12 above the ground also helps to deter rodents from entering the chicken feeder and deters feed waste.

The compact chicken waterer apparatus 12 shown in the Figures holds 6-gallons of water and features an algae-resistant design, unique water nipples 26 for cleanliness, and a versatile handle. The new design eliminates daily maintenance and keeps the water clean and accessible.

The compact chicken feeder apparatus 12 shown in the Figures holds chicken feed and is ideal for indoor and outdoor use. It has openings 281 for receiving the head of a chicken.

Both the chicken feeder and the chicken waterer easily mount on a wooden post 16 or run, or on any substantially vertical surface, utilizing the handle 14 of the apparatus 12. The design utilizes a holder in the form of a support bracket or sleeve 10 that can be positioned at any height and the handle 14 of the apparatus 12 seats in the holder 10. The remainder of the apparatus hangs from the holder 10 but is not positioned inside or through the holder 10. This permits the apparatus to be easily removable from the holder 10 for cleaning and filling. The same handle 14 design may be utilized for both the waterer and the feeder.

The mounting device or holder 10 utilizes a sleeve into which the handle 14 of the feeder or the waterer 12 may be positioned or fitted. Based upon the position that the handle 14 is placed relative to the ground, the height of the feeder and waterer 12 may be adjusted.

The mounting device or holder 10 is a substantially u-shaped sleeve that has a length L1 that is about the same length L2 as the handle of the apparatus, although the sleeve 10 may be longer or shorter than the handle length L2 if desired. The sleeve 1- also has a shape that matches the contours of the handle 14 along at least part of the length L2 of the handle 14.

The U-shaped sleeve 10 has a shape when viewed from above or below the sleeve that includes a substantially flat rear wall 18 that permits the sleeve 10 to be attached in a sturdy manner to a flat surface, like a wall or a post 16. The sleeve may include holes 20 that permit a screw or other fastener to be inserted through the holes 20 to permit the sleeve 10 to be attached to an underlying surface with the fasteners. The U-shape of the sleeve 10 provides two arms that extend outwardly from the flat rear wall 18. The arms curves outwardly from the flat rear wall 18 in a first section 22 of the U-shape and then bend or curve inwardly in a second section 24 of U-shape, which can be parallel or curved depending on the shape of the handle 14. The arms of the U-shape are spaced from one another and the opening of the U-shape is positioned at the front end of the arms 32. At the front end 32 of the U-shaped sleeve, the arms are spaced a distance D that is smaller than the width W1 of the rear end of the U-shape to trap the handle 14 of the apparatus 12 in the sleeve 10.

As is evident, the handle 14 and support member 10 together provide a simple attachment mechanism that is versatile. It can be used with any type of apparatus 12 that is desired to be positioned at different heights. The U-shaped sleeve 10 is open at the front end 32 to permit the handle 14 to slide onto the support member 10. As shown, the apparatus 12 that seats in the support member 10 has a handle 14 that is attached directly to the body of the apparatus 12, or is integral with the body of the apparatus 12, so that no space is provided between the handle 14 and the body of the apparatus 12. Alternatively, the support member 10 could be used with an apparatus 12 that has a handle (not shown) that is separated from the body of the apparatus 12 but coupled to the body of the apparatus at an upper end of the handle.

An elevated height means that the support member is positioned above the ground. The spacing may be minimal, such as ½″ or higher.

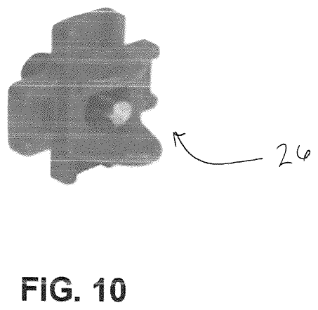

Referring to the Figures, FIGS. 1-7 depict a chicken watering apparatus 12 that comprises a tank-like enclosure having a handle 14 in the rear 30 of the apparatus 12 and a snap-on lid 34 on top of the apparatus 12. Typically, watering nipples 26 are positioned around the sides of the apparatus, such as those shown in FIG. 10. In FIG. 1, the handle 14 of the apparatus 12 is shown positioned above a support bracket or sleeve 10. The support bracket or sleeve 10 is shown coupled to a post 16 and is positioned vertically so that the handle 14 of the apparatus 12 can slide downwardly into the upper opening of the sleeve 10 to couple the handle 14 to the sleeve 10. Because of the geometry of the sleeve 10, the handle 14 is held firmly in position within the sleeve. In addition, because part of the apparatus 36 is positioned above the handle 14, the apparatus 12 serves as a stop so that the handle 14 of the apparatus is held in position within the sleeve 10 and the weight of the apparatus 12, including anything positioned inside the apparatus 12 acts downwardly on the sleeve 10 to keep the apparatus in position within the sleeve 10.

As is evident from FIG. 1, a substantial portion of the apparatus is not positioned inside the sleeve 10, with only the handle 14 being held inside the sleeve 10. This permits the sides, top and bottom of the apparatus to be accessible. The present support structure 10 provides a simple attachment technique that permits the apparatus 12 to be easily removed from the support bracket 10 and replaced. It also permits for an apparatus 12 that has a size that is significantly larger than the handle 14 of the apparatus 12, such as double, triple, quadruple or more, the size of the handle 14. In the examples shown, the apparatus 12 is at least five times greater than the size of the handle 14.

As shown in FIG. 1, the support member is a bracket or sleeve 10 that has a length L1. The length L1 of the support member 10 extends vertically to permit the handle 14 to slide downwardly into the sleeve opening 10. It should be noted that sleeves 10 that utilize the present technology could also be designed to be positioned at an angle, if desired. The sleeve 10 has U-Shape with a rear end 18 that seats against a surface and forms the base of the “U”, such as the post shown 16 in FIG. 1, and a front end 32 that extends outwardly like a pair of arms (forming the other end of the “U”). The base wall 18 of the sleeve 10 is preferably substantially flat or planar so that the sleeve 10 may be attached to an underlying surface, like the post shown in FIG. 1. The arms of the sleeve may be curved or straight as long as they are designed to trap the handle 14 in the sleeve 10. As shown in FIG. 1, the base wall 18 has a width and the arms have a width between them and the width between the arms is less than the width of the base. This further assists in trapping the handle 14 of the apparatus 12 in the sleeve 10.

The profile or cross-section of the sleeve 10 has a flat rear end 18. The profile then bulges outwardly in a curvilinear manner 22 and then curves inwardly 24. This permits for a handle 14 that has a wider rear end to seat in the sleeve 10 and to trap the handle 14 in the sleeve.

The rear wall 18 of the sleeve 10 may include screw holes 20 for fastening the sleeve to a surface. Other fastening techniques may also be utilized, if desired.

Because the sleeve 10 can be positioned at any desired height on an underlying surface, it permits for a variety of heights that the apparatus 12 can be positioned at. If the length L1 of the sleeve 10 is the same as the height of the handle 14, and the handle 14 has a bottom end that is adjacent the bottom 40 of the apparatus 12, the sleeve's 10 position will dictate the height of the apparatus 12 relative to the ground.

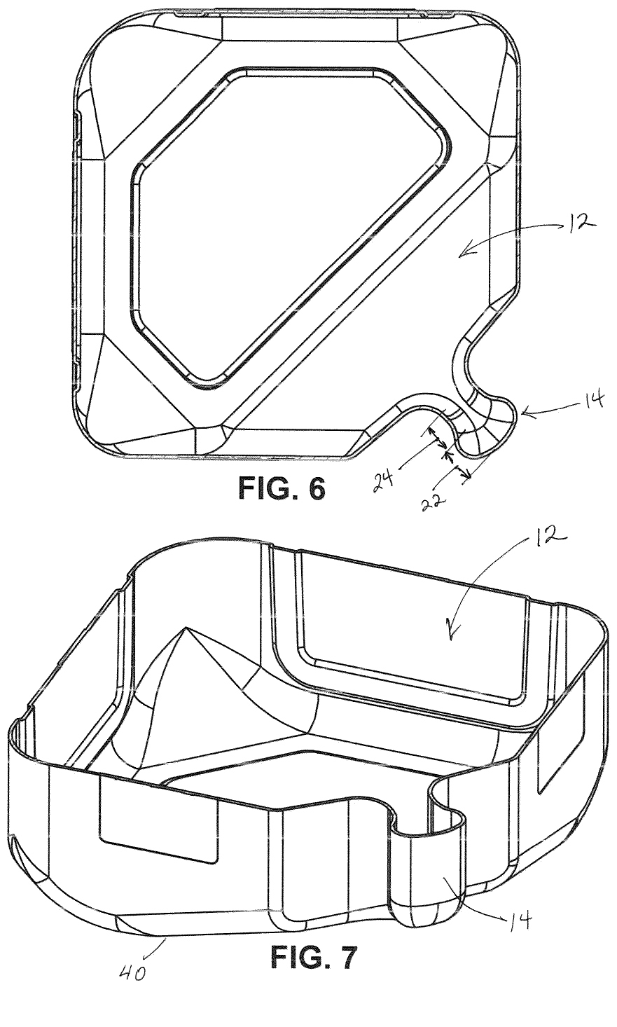

FIGS. 6 and 7 depict top cross-sectional views of the chicken waterer showing the overall shape of the apparatus 12 and the shape of the handle 14. As is evident, the handle 14 is a bulbous protrusion that extends outwardly from the rear corner of the apparatus 12. The handle 14 has a cross-sectional shape that permits it to seat inside the sleeve 10 in a firm manner, although the shape of the handle 14 is not identical to the shape of the sleeve 10. In particular, the handle 14 has an outwardly curved, convex rear end adjacent outwardly curved convex side walls. Then, when the handle 14 approaches the position of the arms of the U-shaped support 10, the handle 14 curves inwardly in a concave manner. The shape of the handle 14 permits it to be trapped inside the sleeve 10.

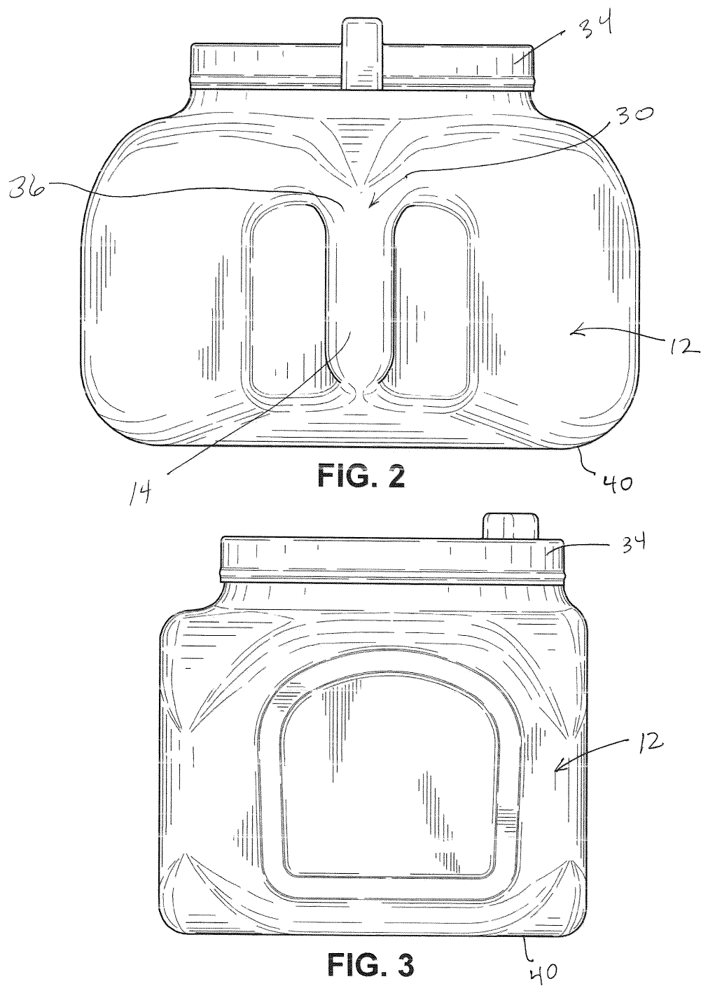

In addition, as shown in FIG. 2, the handle 14 extends along only part of the height of the apparatus 12. The apparatus itself is positioned directly above the handle 14 so that when the handle 14 is placed inside the sleeve, it slides down into the sleeve until the sleeve abuts the upper end of the apparatus 36. The upper end of the apparatus 36 serves as a stop to limit the travel of the handle 14 inside the sleeve 10 and also assists at maintaining the apparatus 12 as a constant height.

FIGS. 11-14 depict an alternative embodiment of the support bracket/sleeve 10. In this embodiment, the sleeve 10 is symmetrical top-to-bottom and includes flared ends 42 that permit the sleeve 10 to be positioned in either orientation, either up or down. The flared ends are advantageous because they help to prevent the bracket 10 from cutting into the plastic material of the apparatus 12. Because the apparatus 12 can hold significant weight (e.g., six gallons of water weighs approximately 50 lbs.), the flared ends 42 help to prevent weighted apparatus 12 from being damaged by the sleeve 10 when under load. In addition, the embodiment shown in FIGS. 11-14 has a lip 44 between the flat rear wall 18, concave curvature of the arms directly adjacent the lip 22 and convex flared ends 24 to the arms. The flared portion of the bracket 10 is associated with the convex flared ends 24 of the arms. In this embodiment the rear wall 18 has a width that is approximately the same as the width between the arms at the narrowest point on the arms but is narrower than the widest point on the arms. The width of the arms at the end thereof is also wider than the width of the rear wall. FIG. 12 also depicts the location for the screw holes 20 that are used to couple the bracket 10 to a surface 16. The lip 44 that is positioned adjacent the rear wall 18 provides space for the heads of the screws so that they do not interfere with the end of the handle 14 when the handle 14 is installed in the sleeve 10.

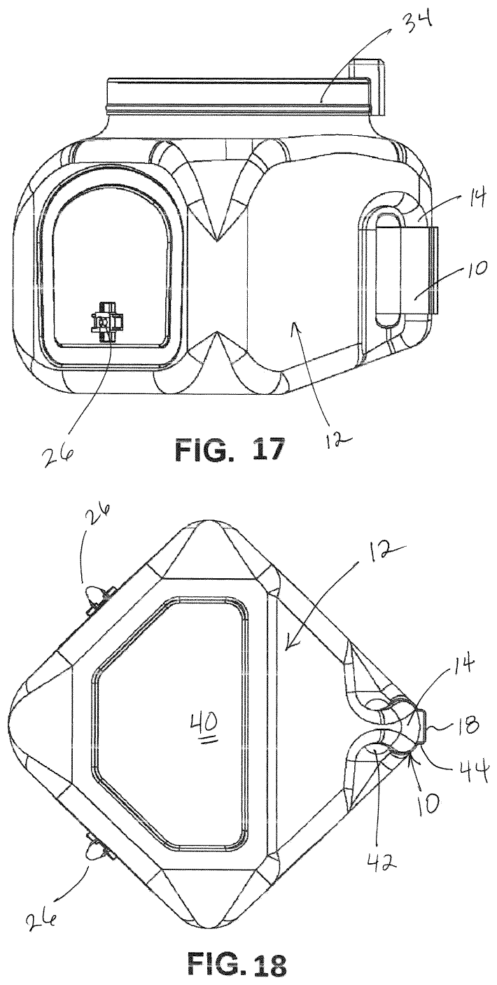

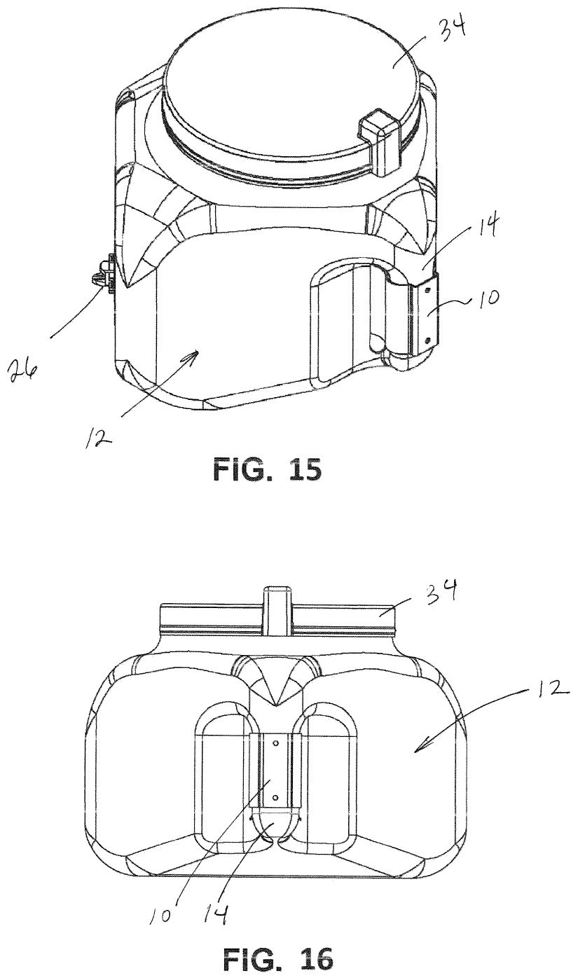

FIGS. 15-18 depict an alternative embodiment of the poultry feeder along with the support bracket 10 shown in FIGS. 11-14. As shown, the support bracket flared arms 24 mate with the handle 14 of the apparatus 12 to support the apparatus 12 on the bracket 10. In this embodiment, the support bracket 10 has a length that is less than the length of the handle 14. FIG. 18 depicts a bottom view of the handle 14 installed in the bracket 10 and shows the space provided adjacent the rear wall 18 of the bracket 10 due to the existence of the lip 44. FIG. 18 also shows the close connection between the handle 14 and the shape of the bracket 10. The shape of the handle 14 is complementary to the shape of the bracket 10.

The feeder and waterer can be designed to be used with other types of birds, or with other animals, if desired. The handle 14 design is usable with other types of devices that need to be mounted relative to the ground or other surface but need adjustability in terms of height.

The bottom surface of the feeder and/or waterer may be flat or indented. The top end of the apparatus 12 may include a lid 34, such as shown, or be open or closed. The overall shape of the apparatus 12 is not critical to the invention as the apparatus 12 may be any type of apparatus 12. For example, the apparatus 12 utilizing the support bracket 10 could be a cup having an open top that is used for holding nails on a structure having a plurality of support brackets arranged in side-by-side relation.

In a first embodiment, a support mounting mechanism for mounting an apparatus 12 at an elevated height on a surface includes a support sleeve and an apparatus 12 having a handle 14. The support sleeve has a substantially U-shaped profile and a length. The U-shape has a closed rear end and an open front end, and the rear end of the U-shape is attachable to the surface. The handle 14 of the apparatus 12 has a length and a cross-sectional shape that seats in the U-shaped sleeve to hold the apparatus 12 at the elevated height. The handle 14 extends along part of the height of the apparatus 12 and the apparatus 12 has an upper portion positioned above the handle 14 that has a width that is larger than the width of the U-shaped profile. The upper portion of the apparatus 12 serves as a stop so that only part of the apparatus 12 sits on top of the support sleeve. Part of the apparatus 12 extends outwardly from the support sleeve to suspend the apparatus 12 at the elevated height.

The closed rear end of the support sleeve may be a rear wall having a first width. The open front end may include two outwardly extending arms that provide a second width, with the first width being greater than the second width. The two outwardly extending arms are a mirror image of each other and have a shape that is a concavely curved adjacent the rear wall and convexly curved at the open front end. The concavely curved portion of the support bracket 10 has a third width, and the third width is greater than both the first width and the second width.

The closed rear end of the support sleeve may be a rear wall having a first width and a lip positioned adjacent the rear wall that provides a rectangular space adjacent the rear end of the support sleeve. The support sleeve has two arms that extend outwardly from the lip on either side of the rear wall. The two arms are a mirror image of each other and have a shape that is concavely curved adjacent the rear wall and convexly curved at the open end of the arms. A width between the convexly curved arms is approximately the same width as a width of the rear wall. A flared portion is coupled to the arms at the convexly curved portion thereof.

The length of the support bracket 10 is substantially the same as the length of the handle 14. Alternatively, the length of the support bracket 10 is shorter than the length of the handle 14. Alternatively, the length of the support bracket 10 is longer than the length of the handle 14. The handle 14 of the apparatus 12 is integral with the apparatus 12.

The apparatus 12 may have a first portion that is positioned outside of the support bracket 10 and a second portion that is positioned inside the support bracket 10, with the second portion being the handle 14. The first portion is a chicken feeder or a chicken waterer having one or more access points for chickens.

The surface may be a substantially vertical surface.

The handle 14 may have a cross-sectional shape that has a curved outer end and sides. The curved outer end may have a first handle width and the sides form a waist having a second handle width at a narrowest point, and the second handle width is smaller than the first handle width. The outer end of the handle 14 is continuously curved outwardly and the sides of the handle 14 are continuously curved inwardly.

The support sleeve may have a strength capable of supporting an apparatus 12 that is 5 or more times the size of the handle 14.

In another embodiment, a support mechanism for holding an apparatus 12 at an elevated height above the ground includes a support bracket 10 having a height and a width. The support bracket 10 has a contour along its length that permits a handle 14 having a similarly shaped contour to seat in the support bracket 10 to hold an attached apparatus 12 at the elevated height. The bracket 10 has a U-shaped profile with a closed rear end that is configured to attach to a separate supporting structure, an open front end, an open bottom end, and an open top end. The support bracket 10 is shaped to accept a handle 14 of an apparatus 12 that slides downwardly into the support bracket 10. The apparatus 12 is supported on the support bracket 10 by a portion of the apparatus 12 that is positioned above the handle 14 of the apparatus 12. The support bracket 10 is configured to suspend an apparatus 12 above the ground solely by contact between the handle 14 of the apparatus 12 and the support bracket 10.

The support bracket 10 at the closed rear end has a first width and the support bracket 10 at the open front end has a second width. The second width is smaller than or equal to the first width, with the second width being the smallest distance between the two arms.

The closed rear end of the support bracket 10 has a substantially flat surface for attaching to a separate flat surface. The open front end of the support bracket 10 has convexly curved arms and flared tips.

The support bracket 10 has a rear wall at the rear end and the rear wall has a width that is about greater than or equal to the second width. The support bracket 10 is made from a material that has a thickness that is substantially constant and a strength sufficient to support an apparatus 12 that is suspended by a handle 14 positioned in the support bracket 10.

The support bracket 10 may be made of any type of material, including metal or plastic. The apparatus 12 can also be made of any type of material. The term “substantially,” as used herein,

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially,” if used herein, means the specified materials or steps and those that do not materially affect the basic and novel characteristics of the material or method. The articles “a,” “an,” and “the,” should be interpreted to mean “one or more” unless the context indicates the contrary.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A support mounting mechanism for mounting an apparatus at an elevated height on a surface comprising:
a support sleeve that has a substantially U-shaped profile and a length, with the U-shape having a closed rear end and an open front end, and the rear end of the U-shape is attachable to the surface; and
an apparatus having a handle with a length and a cross-sectional shape that seats in the U-shaped sleeve to hold the apparatus at the elevated height, wherein the handle extends along part of the height of the apparatus and the apparatus has an upper portion positioned above the handle that has a width that is larger than the width of the U-shaped profile, the upper portion of the apparatus serves as a stop so that only part of the apparatus sits on top of the support sleeve, and part of the apparatus extends outwardly from the support sleeve to suspend the apparatus at the elevated height.

2. The support mounting mechanism of claim 1, wherein the closed rear end of the support sleeve is a rear wall having a first width and an open front end is two outwardly extending arms that provide a second width, and the first width is greater than the second width.

3. The support mounting mechanism of claim 2, wherein the two outwardly extending arms are a mirror image of each other and have a shape that is a concavely curved adjacent the rear wall and convexly curved at the open front end.

4. The support mounting mechanism of claim 2, wherein the concavely curved portion of the support bracket has a third width, and the third width is greater than both the first width and the second width.

5. The support mounting mechanism of claim 1, wherein the closed rear end of the support sleeve is a rear wall having a first width and a lip positioned adjacent the rear wall that provides a rectangular space adjacent the rear end of the support sleeve, and the support sleeve has two arms that extend outwardly from the lip on either side of the rear wall.

6. The support mounting mechanism of claim 5, wherein the two arms are a mirror image of each other and have a shape that is concavely curved adjacent the rear wall and convexly curved at the open end of the arms, with a width between the convexly curved arms being approximately the same width as a width of the rear wall, and further comprising a flared portion coupled to the arms at the convexly curved portion thereof.

7. The support mounting apparatus of claim 1, wherein the length of the support bracket is substantially the same as the length of the handle, or
the length of the support bracket is shorter than the length of the handle, or
the length of the support bracket is longer than the length of the handle.

8. The support mounting apparatus of claim 1, wherein the handle of the apparatus is integral with the apparatus.

9. The support mounting apparatus of claim 1, wherein the apparatus has a first portion that is positioned outside of the support bracket and a second portion that is positioned inside the support bracket, with the second portion being the handle.

10. The support mounting apparatus of claim 9, wherein the first portion is a chicken feeder or a chicken waterer having one or more access points for chickens.

11. The support mounting apparatus of claim 1, wherein the surface is a substantially vertical surface.

12. The support mounting apparatus of claim 1, wherein the handle has a cross-sectional shape that has a curved outer end and sides, and the curved outer end has a first handle width and the sides form a waist having a second handle width at a narrowest point, and the second handle width is smaller than the first handle width.

13. The support mounting apparatus of claim 12, wherein the outer end of the handle is continuously curved outwardly and the sides of the handle are continuously curved inwardly.

14. The support mounting apparatus of claim 1, wherein the support sleeve has a strength capable of supporting an apparatus that is 5 or more times the size of the handle.

15. A support mechanism for holding an apparatus at an elevated height above the ground comprising:
a support bracket having a height and a width, wherein the support bracket has a contour along its length that permits a handle having a similarly shaped contour to seat in the support bracket to hold an attached apparatus at the elevated height, wherein the bracket has a U-shaped profile with a closed rear end that is configured to attach to a separate supporting structure, an open front end, an open bottom end, and an open top end, and the support bracket is shaped to accept a handle of an apparatus that slides downwardly into the support bracket, with the apparatus being supported on the support bracket by a portion of the apparatus that is positioned above the handle of the apparatus,
wherein the support bracket is configured to suspend an apparatus above the ground solely by contact between the handle of the apparatus and the support bracket.

16. The support mechanism of claim 15, wherein the support bracket at the closed rear end has a first width and the support bracket at the open front end has a second width, with the second width being smaller than or equal to the first width, with the second width being the smallest width between the two arms.

17. The support mechanism of claim 15, wherein the closed rear end of the support bracket has a substantially flat surface for attaching to a separate flat surface.

18. The support mechanism of claim 15, wherein the open front end of the support bracket has convexly curved arms and flared tips.

19. The support mechanism of claim 15, wherein the support bracket has a rear wall at the rear end and the rear wall has a width that is about greater than or equal to the second width.

20. The support mechanism of claim 15, wherein the support bracket is made from a material that has a thickness that is substantially constant and a strength sufficient to support an apparatus that is suspended by a handle positioned in the support bracket.
